(19) United States
(12) Patent Application Publication
(10) Pub. No.: US 2026/0201992 A1
(43) Pub. Date: Jul. 16, 2026

(54) FLUID CONNECTOR ASSEMBLY

(71) Applicant: GM GLOBAL TECHNOLOGY OPERATIONS LLC, Detroit, MI (US)

(72) Inventors: Victor Wong, Lake Orion, MI (US); Kyle P. Nolan, Royal Oak, MI (US); Andrew Kacherski, Royal Oak, MI (US); Jeffrey S. Shotwell, Clarkston, MI (US); Owen Rauch, Howell, MI (US)

(73) Assignee: GM GLOBAL TECHNOLOGY OPERATIONS LLC, (omitted)

(21) Appl. No.: 19/022,078

(22) Filed: Jan. 15, 2025

(51) Int. Cl. F16L 37/086

(52) U.S. Cl. CPC F16L 37/086

(57) ABSTRACT

A fluid connector assembly includes two identical connector members. Each connector member includes a connector member body arranged along a longitudinal axis. The connector member body includes a first body end configured to couple with and hermetically seal to the first body end of the other connector member and a second body end configured to attach to a fluid conduit. The connector member body also defines an inner fluid passage arranged concentrically around the longitudinal axis. The connector member body additionally includes a projection arranged on the first body end and spaced from and extending parallel to the longitudinal axis. Furthermore, the connector member body defines a channel configured to accept the projection of the other connector member, when the two connector members are turned 180 degrees relative to each other about the longitudinal axis.

### INTRODUCTION

The present disclosure relates to a fluid connector assembly, such as for a cooling subsystem of a motor vehicle.

Fluid connectors or fittings play a crucial role in industrial systems, ensuring reliable, leak-free connections between hoses, pipes, and tubes. Fluid connectors allow multiple pipes to be connected to cover longer distances or extend a network by branching and make possible more complex systems than could be achieved with only individual pipes.

Quick-connect fittings are designed to be easier to use than traditional fittings and are used to provide a fast, make-or-break connection of gas or liquid transfer lines. Operated by hand, quick connect fittings replace threaded or flanged connections, which require wrenches.

In motor vehicles, fluid connectors may be employed to couple fluid lines circulating coolant through heat exchangers to thermally regulate various systems. In electric vehicles, a heat-sink or cold plate embodiment of heat exchanger may be used to remove heat from battery cells and other components of a multi-cell rechargeable energy storage system (RESS).

### SUMMARY

A fluid connector assembly includes two identical, a first and a second, connector members. Each connector member includes a connector member body disposed along a longitudinal axis. The connector member body includes a first body end configured to couple with and hermetically seal to the first body end of the other connector member and a second body end configured to attach to a fluid conduit. The connector member body also defines an inner fluid passage arranged concentrically around the longitudinal axis. The connector member body additionally includes a projection arranged on the first body end and spaced from and extending parallel to the longitudinal axis. Furthermore, the connector member body defines a channel configured to accept the projection of the other connector member, when the two connector members are turned 180 degrees relative to each other about the longitudinal axis.

The fluid connector assembly may also include a first spring clip and a second spring clip, together configured to fasten the two connector members.

The connector member body of each connector member may additionally define a first slot and a second slot. In such an embodiment, each of the first slot of the first connector member and the second slot of the second connector member may be configured to accept the first spring clip. Additionally, in the same embodiment, each of the second slot of the first connector member and the first slot of the second connector member may be configured to accept the second spring clip.

The first slot may extend through the channel and the second slot may extend through the projection.

The connector member body may additionally define a conduit engagement surface arranged opposite the projection.

The conduit engagement surface may include one or more barbs configured to fix and maintain engagement of the conduit with the corresponding connector member body.

The projection may include a beveled free end configured to pilot the subject projection into the channel of the other connector member.

The connector member body may have a cylindrical shape defined by a circumference thereof. In such an embodiment, the projection and the channel may be arranged 180 degrees apart relative to the longitudinal axis. Additionally, each of the projection and the channel may extend around half the circumference of the cylindrical shape.

At least one of the connector members may additionally include an elastic element arranged on the first body end and be configured to seal the two coupled first body ends of the first and second connector members. The elastic element may be a flat washer or an O-ring.

A fluid conduit assembly including a first fluid conduit and a second fluid conduit connected or joined using the fluid connector assembly, as described above, is also disclosed.

Additionally disclosed is a cooling system having such a fluid conduit assembly configured to circulate coolant through a fluid heat exchanger.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic top view of an embodiment of a motor vehicle employing various vehicle systems and corresponding cooling systems employing heat exchangers circulating coolant via respective fluid conduit assemblies, according to the disclosure.

FIG. 2 is a close-up schematic partial side view of a representative fluid conduit assembly shown in FIG. 1, illustrating two fluid conduits joined using a fluid connector assembly having two identical connector members, according to the disclosure.

FIG. 3 is a schematic cross-sectional side view of the fluid connector assembly shown in FIG. 2, illustrating details of the connector members, according to the disclosure.

FIG. 4 is a schematic perspective top view of one of the fluid connector members shown in FIG. 3, according to the disclosure.

### DETAILED DESCRIPTION

Embodiments of the present disclosure as described herein are intended to serve as examples. Other embodiments may take various and alternative forms. Additionally, the drawings are generally schematic and not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure.

Certain terminology may be used in the following description for the purpose of reference only, and thus are not intended to be limiting. For example, terms such as “above” and “below” refer to directions in the drawings to which reference is made. Terms such as “front”, “back”, “fore”, “aft”, “left”, “right”, “rear”, “side”, “upward”, “downward”, “top”, and “bottom”, etc., describe the orientation and/or location of portions of the components or elements within a consistent but arbitrary frame of reference, which is made clear by reference to the text and the associated drawings describing the components or elements under discussion. Furthermore, terms such as “first”, “second”, “third”, and so on may be used to describe separate components. Such terminology may include the words specifically mentioned above, derivatives thereof, and words of similar import, and are used descriptively for the figures, and do not represent limitations on the scope of the disclosure, as defined by the appended claims

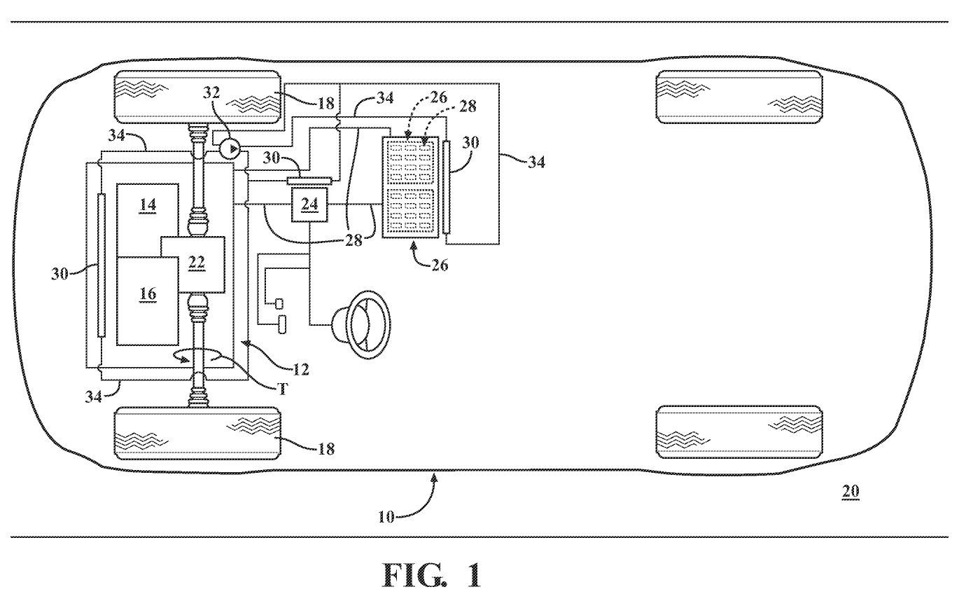

Referring to FIG. 1, a motor vehicle 10 having a powertrain 12 is depicted. The vehicle 10 may include, but not be limited to, a commercial vehicle, industrial vehicle, passenger vehicle, aircraft, watercraft, train or the like. It is also contemplated that the vehicle 10 may be a mobile platform, such as an airplane, all-terrain vehicle (ATV), boat, personal movement apparatus, robot and the like to accomplish the purposes of this disclosure. The powertrain 12 includes one or more power-sources, such as a traction motor or electric motor-generator 14 and/or an internal combustion engine 16, configured to generate a power-source torque T (shown in FIG. 1) for propulsion of the vehicle 10 via driven wheels 18 relative to a road surface 20. For example, the power-sources 14 and 16 may act in concert to power the vehicle 10. As shown, the powertrain 12 may additionally include a transmission assembly 22 operatively connecting the power-sources(s) to the driven wheels 18 for transmitting drive torque T thereto.

As shown, vehicle 10 additionally includes an electronic controller 24. The electronic controller 24 may be a central processing unit (CPU) that regulates various functions on the vehicle 10, or as a powertrain control module (PCM) configured to control the powertrain 12 to generate a predetermined amount of power-source torque T. The vehicle 10 also includes a multi-cell rechargeable energy storage system (RESS) 26 configured to generate and store electrical energy through heat-producing electro-chemical reactions for supplying the electrical energy to the powertrain 12 and the controller 24. The RESS 26 may be connected to the power-sources 14 and 16, the electronic controller 24, as well as other vehicle systems via a high-voltage BUS 28.

Vehicle systems, such as power-sources 14 and 16, transmission assembly 22, and RESS 26 typically generate thermal energy as a byproduct of their operation. However, such systems may start their operation from a relatively cold state at which system efficiency is below optimum. Accordingly, thermal energy needs to be effectively managed to enhance system efficiency on the one hand and mitigate heat build-up and consequent degradation of system performance and reliability on the other. To such an end, vehicle 10 also includes heat exchangers 30 configured to circulate coolant and thereby regulate, e.g., either add or remove, thermal energy in such vehicle systems. Accordingly, powertrain 12, electronic controller 24, and RESS 26 may be representative of the vehicle systems employing heat exchangers 30 for thermal regulation thereof. Appropriate heat exchangers 30 may be incorporated as subassemblies into the corresponding vehicle systems or be arranged remotely thereto.

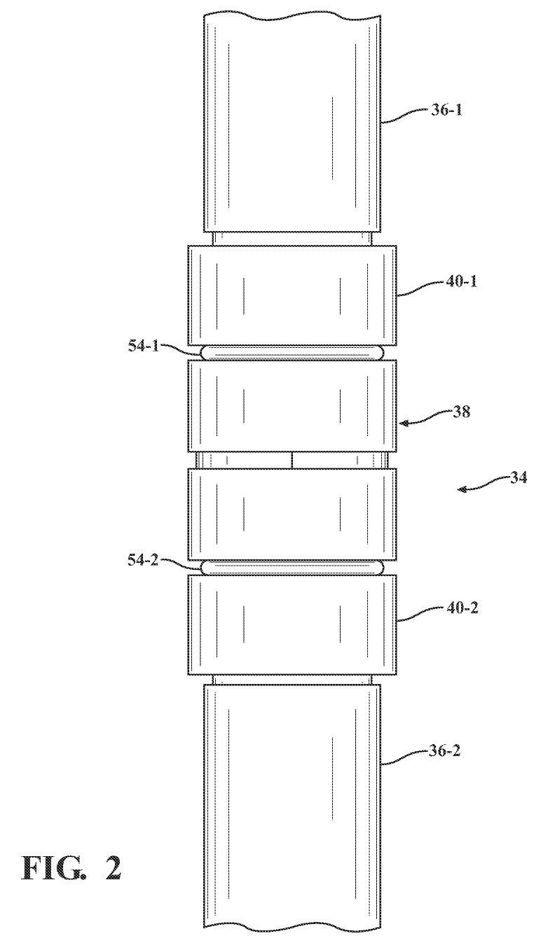

As shown in FIG. 1, a representative heat exchanger 30 is typically connected to a fluid pump 32 via fluid conduit assemblies 34, such as a fluid inlet conduit and a fluid outlet conduit. As shown in FIG. 2, each fluid conduit assembly 34 includes a first fluid conduit 36-1 and a second fluid conduit 36-2 configured to be connected or coupled together. Each fluid conduit 36-1, 36-2 may employ flexible hoses or include flexible hose portion(s) connected to rigid pipe(s). Each fluid conduit assembly 34 also includes a fluid connector assembly 38 having two substantially identical (as permitted by manufacturing tolerances), asymmetrical or single-sided connector members - a first connector member 40-1 and a second connector member 40-2. The first and second connector members 40-1, 40-2 are configured to join the respective first and second fluid conduits 36-1, 36-2.

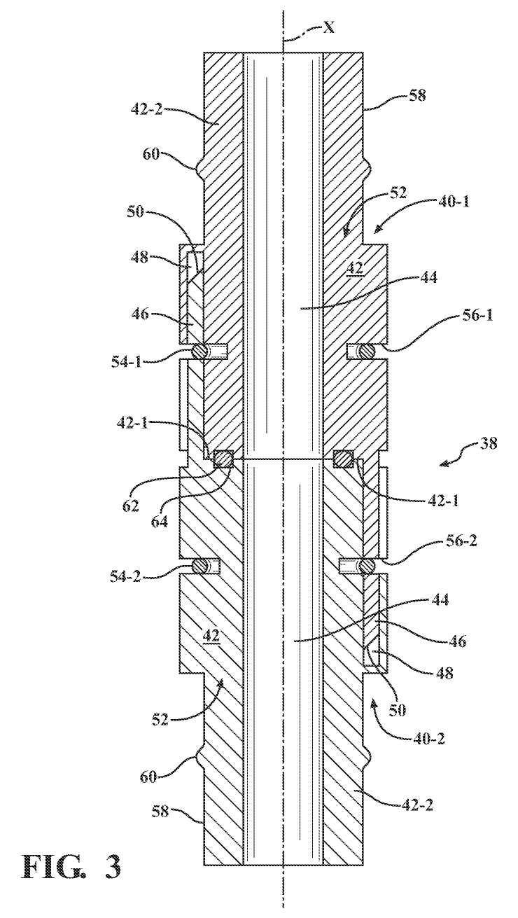

With reference to FIG. 3, each connector member 40-1, 40-2 includes a connector member body 42 having a first body end 42-1 configured to couple with and hermetically seal (generating a fluid-tight connection) to the first body end of the other connector member. The connector member body 42 may be either injection molded from a polymer or cast or machined from metal, such as aluminum. The connector member body 42 of each connector member 40-1, 40-2 also includes a second body end 42-2 configured to attach to a corresponding one of the first and second fluid conduits 36-1, 36-2. As shown in FIG. 2, the connector member body 42 of each connector member 40-1, 40-2 may have a generally circular cross-section. The connector member body 42 is disposed along a longitudinal axis X (shown in FIG. 3) and defines an inner fluid passage 44 arranged concentrically around the longitudinal axis. Each connector member body 42 may also include a projection 46 arranged on the first body end 42-1, spaced from and extending parallel to the longitudinal axis X.

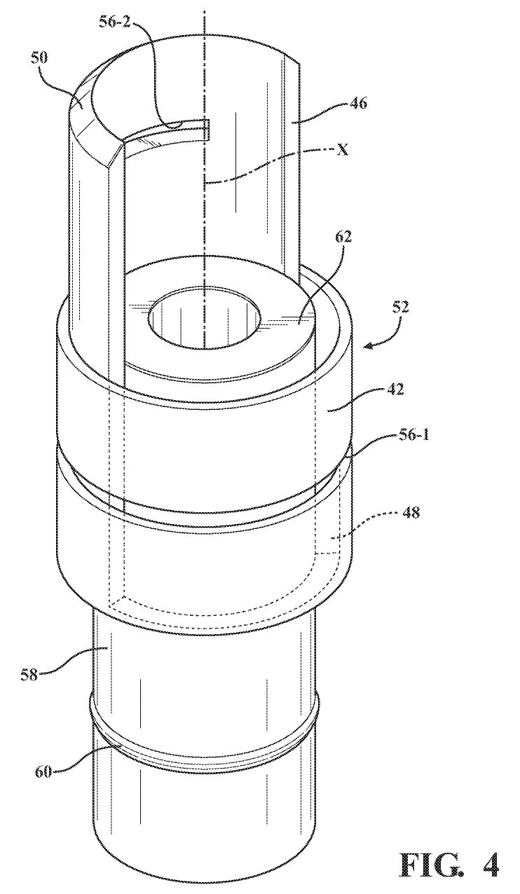

With resumed reference to FIG. 3, each connector member body 42 may additionally define a channel or pocket 48. The channel 48 of one connector member is configured to accept the projection 46 of the other mating connector member, when the two connector members 40-1, 40-2 are turned 180 degrees relative to each other about the longitudinal axis X (as shown in FIG. 3). The projection 46 of each member body 40 may include a beveled free end 50 configured to pilot the subject projection into the channel 48 of the other connector member. As illustrated in FIG. 4, the connector member body 42 may have a generally cylindrical shape 52 generally defined by a circumference thereof. With reference to FIG. 3, the projection 46 and the channel 48 may be arranged substantially 180 degrees apart relative to the longitudinal axis X. Furthermore, each of the projection 46 and the channel 48 may extend substantially around half the circumference of, i.e., occupy a 180-degree arc around, the cylindrical shape 52.

With reference to FIGS. 2 and 3, each connector member 40-1, 40-2 may also include a first spring clip 54-1 and a second spring clip 54-2. The first and second spring clips 54-1, 54-2 are together configured to fasten the two connector members 40-1, 40-2 to each other. As shown, the connector member body 42 of each connector member 40-1, 40-2 may also define a first slot 56-1 and a second slot 56-2. In the subject embodiment, each of the first slot 56-1 of the first connector member 40-1 and the second slot 56-2 of the second connector member 40-2 may be configured to accept the first spring clip 54-1. Additionally, in the same embodiment, each of the second slot 56-2 of the first connector member 40-1 and the first slot 56-1 of the second connector member 40-2 may be configured to accept the second spring clip 54-2.

As shown in FIG. 3, the first slot 56-1 may extend substantially orthogonally through the channel 48 and the second slot 56-2 may extend substantially orthogonally through the projection 46. Once seated in the respective channel slots 56-1, during engagement of the two connector members 40-1, 40-2, the first and second spring clips 54-1, 54-2 are expanded by the corresponding projections 46 until the spring clips snap into the projection slots 56-2. The beveled free end 50 of each projection 46 may aid the expansion of the spring clips 54-1, 54-2 as the two connector members 40-1, 40-2 are being engaged and enable the spring clips to seat in the respective projection slots 56-2. As aa result, the spring clips 54-1, 54-2 may engage the connector member body 42 of each connector member 40-1, 40-2 and thereby lock the two connector members together.

The connector member body 42 may also define a conduit engagement surface 58 (shown in FIG. 3) arranged proximate the second body end 42-2 opposite the projection 46. The conduit engagement surface 58 may include one or more barbs 60 configured to fix and maintain engagement of the respective fluid conduit 36-1, 36-2 with the corresponding connector member body 42. Although not shown, clamps may be used to further secure fluid conduit 36-1, 36-2 to the respective connector members 40-1, 40-2. As shown in FIG. 4, each connector member 40-1, 40-2 may additionally include an elastic element or gasket 62 arranged on the first body end 42-1. The elastic element 62 may, for example, be a flat rubber ring or washer. The elastic elements 62 may be separate components, each seated on the respective first body end 42-1 as well as mounted thereto, e.g., by an epoxy, or be injection molded together with the respective connector member body 42. The elastic element 62 is configured to seal the two coupled first body ends 43-1 of the first and second connector members 40-1, 40-2.

Alternatively, the elastic element 62 may be an O-ring (shown in FIG. 3). In such an embodiment, the fluid connector assembly 38 may include a single O-ring arranged between the two connector members 40-1, 40-2. The O-ring may be compressed by the connector members 40-1, 40-2 in the fluid connector assembly 38. In such an embodiment, the first body end 42-1 of each connector member 40-1, 40-2 may define a complementary groove 64 configured to seat the O-ring. The subject grooves 64 may be defined by a depth that is shallower than the radius of the O-ring to facilitate appropriate O-ring compression. To ease assembly, the O-ring may be mounted to one of the connector members 40-1, 40-2, e.g., by an epoxy.

Overall, the fluid connector assembly 38 is generated using two coupled identical asymmetrical connector members. The two connector members are constructed to fit together when arranged opposite or 180 degrees relative to one another about a common longitudinal axis. Each connector member includes features such as a projection and a channel configured to accept such a projection to fix the two connector members relative to each other. Gasket(s) may be provided at the interface between individual connector members to ensure a hermetic seal is maintained. The fluid conduit assembly also includes clips configured to lock the connector members relative to each other and achieve a reliable, leak-free assembly. The subject fluid connector assembly may be used to generate low or moderate pressure conduit assemblies, such as for circulating coolant between heat exchangers and vehicle systems.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A fluid conduit assembly comprising:
a first fluid conduit and a second fluid conduit;
a fluid connector assembly having two identical, a first and a second, connector members configured to join the first and second fluid conduits, wherein each connector member includes a connector member body having:
a first body end configured to couple with and hermetically seal to the first body end of the other connector member; and
a second body end configured to attach to one of the first and second fluid conduits.

2. The fluid conduit assembly of claim 1, wherein the connector member body of each connector member is disposed along a longitudinal axis and defines an inner fluid passage arranged concentrically around the longitudinal axis, includes a projection arranged on the first body end and spaced from and extending parallel to the longitudinal axis, and defines a channel configured to accept the projection of the other connector member, when the two connector members are turned 180 degrees relative to each other about the longitudinal axis.

3. The fluid conduit assembly of claim 2, further comprising a first spring clip and a second spring clip, together configured to fasten the two connector members to each other.

4. The fluid conduit assembly of claim 3, wherein:
the connector member body of each connector member additionally defines a first slot and a second slot;
each of the first slot of the first connector member and the second slot of the second connector member is configured to accept the first spring clip; and
each of the second slot of the first connector member and the first slot of the second connector member is configured to accept the second spring clip.

5. The fluid conduit assembly of claim 4, wherein the first slot extends through the channel and the second slot extends through the projection.

6. The fluid conduit assembly of claim 2, wherein the connector member body additionally defines a conduit engagement surface arranged opposite the projection.

7. The fluid conduit assembly of claim 6, wherein the conduit engagement surface includes one or more barbs configured to fix and maintain engagement of the conduit with the corresponding connector member body.

8. The fluid conduit assembly of claim 2, wherein the projection includes a beveled free end configured to pilot the subject projection into the channel of the other connector member.

9. The fluid conduit assembly of claim 2, wherein:
the connector member body has a cylindrical shape defined by a circumference;
the projection and the channel are arranged 180 degrees apart relative to the longitudinal axis; and
each of the projection and the channel extends around half the circumference of the cylindrical shape.

10. The fluid conduit assembly of claim 1, wherein at least one connector member additionally includes an elastic element arranged on the first body end and configured to seal the two coupled first body ends of the first and second connector members.

11. A fluid connector assembly comprising:
two identical, a first and a second, connector members, wherein each connector member includes a connector member body disposed along a longitudinal axis, wherein the connector member body:
includes a first body end configured to couple with and hermetically seal to the first body end of the other connector member and a second body end configured to attach to a fluid conduit;
defines an inner fluid passage arranged concentrically around the longitudinal axis;
includes a projection arranged on the first body end and spaced from and extending parallel to the longitudinal axis; and
defines a channel configured to accept the projection of the other connector member, when the two connector members are turned 180 degrees relative to each other about the longitudinal axis.

12. The fluid connector assembly of claim 11, further comprising a first spring clip and a second spring clip, together configured to fasten the two connector members to each other.

13. The fluid connector assembly of claim 12, wherein:
the connector member body of each connector member additionally defines a first slot and a second slot;
each of the first slot of the first connector member and the second slot of the second connector member is configured to accept the first spring clip; and
each of the second slot of the first connector member and the first slot of the second connector member is configured to accept the second spring clip.

14. The fluid connector assembly of claim 13, wherein the first slot extends through the channel and the second slot extends through the projection.

15. The fluid connector assembly of claim 11, wherein the connector member body additionally defines a conduit engagement surface arranged opposite the projection.

16. The fluid connector assembly of claim 15, wherein the conduit engagement surface includes one or more barbs configured to fix and maintain engagement of the respective conduit with the corresponding connector member body.

17. The fluid connector assembly of claim 11, wherein the projection includes a beveled free end configured to pilot the subject projection into the channel of the other connector member.

18. The fluid connector assembly of claim 11, wherein:
the connector member body has a cylindrical shape defined by a circumference;
the projection and the channel are arranged 180 degrees apart relative to the longitudinal axis; and
each of the projection and the channel extends around half the circumference of the cylindrical shape.

19. The fluid connector assembly of claim 11, wherein at least one connector member additionally includes an elastic element arranged on the first body end and configured to seal the two coupled first body ends of the first and second connector members.

20. A cooling system comprising:
a fluid heat exchanger;
a fluid conduit assembly configured to circulate coolant through the fluid heat exchanger, the fluid conduit assembly comprising:
a first fluid conduit and a second fluid conduit;
a fluid connector assembly having two identical, a first and a second, connector members configured to join the first and second fluid conduits, wherein each connector member includes a connector member body having:
a first body end configured to couple with and hermetically seal to the first body end of the other connector member; and
a second body end configured to attach to one of the first and second fluid conduits;
wherein the connector member body of each connector member is disposed along a longitudinal axis and defines an inner fluid passage arranged concentrically around the longitudinal axis, includes a projection arranged on the first body end and spaced from and extending parallel to the longitudinal axis, and defines a channel configured to accept the projection of the other connector member, when the two connector members are turned 180 degrees relative to each other about the longitudinal axis.
